(19) United States
(12) Patent Application Publication
(10) Pub. No.: US 2012/0309209 A1
(43) Pub. Date: Dec. 6, 2012

(54) ROTATABLE NIGHT LAMP HOLDER

(76) Inventor: Jinhui Zhou, Donguan (CN)

(21) Appl. No.: 13/585,820

(22) Filed: Aug. 14, 2012

(51) Int. Cl. H01R 39/00

(52) U.S. Cl. 439/21

(57) ABSTRACT

present invention provides a night lamp which the holder is rotatable along the plug, comprises a shell and a plug, said shell is assembled by a front holder and rear holder, a joint for installing the bulb is positioned on the top of said shell, and the laminated electrodes for electrical connection between the bulb and the holder is solid mounted inside said joint; a rotatable plug unit is installed on the back of said rear holder, and said plug unit also comprises an annular jammer, which is fixed on said shell by screws, the plug unit is connected to said shell by said annular jammer which also makes the plug unit become rotatable, thus, user can rotate said shell and the bulb which is installed on it to meet desirable angle.

### FIELD

Present invention relates to a night lamp, particularly to a rotatable night lamp holder which can be rotated along the plug, but not influence the operation and electrical connection of the night lamp.

### BACKGROUND OF THE INVENTION

Night lamp is a tool for assist illumination at night, the illumination intensity is weaker than normal lamp, which can provide basic light to prevent user from falling or collision at night.

In prior art, the holder of night lamp includes a plug, and the bulb is installed on the holder, directly insert the plug into the outlet, and turn on the switch, the bulb starts lighting. As aforementioned, the structure of conventional night lamp is simple, and the plug is solid fixed on the holder, thus, user can't adjust desirable angle of the holder once the plug is inserted into the outlet.

### SUMMARY OF THE INVENTION

To overcome the disadvantage mentioned above, present invention provides a night lamp which the holder is rotatable along the plug, comprises a shell and a plug, said shell is assembled by a front holder and rear holder, a joint for installing the bulb is positioned on the top of said shell, and the laminated electrodes for electrical connection between the bulb and the holder is solid mounted inside said joint; a rotatable plug unit is installed on the back of said rear holder, the conducting plates are solid fixed on said plug unit; and said plug unit also comprises an annular jammer, which is fixed on said shell by screws, the plug unit is connected to said shell by said annular jammer which also makes the plug unit become rotatable; said electrodes inside the joint is separately connected with correspond conducting plate on the plug. The triggering switch is disposed between one of pairs of the electrode and conducting plate.

Furthermore, said conducting plates are separately electrical connected with large and small conductive rings which are and disposed as a concentric cylinder; one of said electrodes is connected to the large conductive ring through said triggering switch, another is connected to the small conductive ring.

Furthermore, there is a socket which is formed on the tail of said conducting plate, the edge of said large conductive ring is inserted into said socket; the tail of another conducting plate is bended at the position which is connected to the small conductive ring to form a contact between them, a socket is also formed on the tail of the conducting plate which is connected to the small conductive ring, for the insertion of the edge of said small conductive ring.

Furthermore, a switch button is disposed on the front holder of said shell, the button works with said triggering switch for linking or cutting the electrical connection between said electrode and large conductive ring.

Furthermore, said front and rear holder is fixed and assembled by the screws which are for fixing said annular jammer on said shell.

The advantages of present invention compares to prior art, are as following:

1. The plug unit is rotatable when it is instilled on the shell, thus, user can rotate said shell and the bulb which is installed on it to meet desirable angle.

2. The electrical connections among the parts of present invention are by realized contacting, the conducting plate on the plug contacts to the conductive ring; the electrode inside the joint also contacts to the conductive ring, thus, whether which angle between the plug and the shell is formed by rotating said shell, the electrical connections among the parts of present invention are still restored, and the situation of electricity interruption due to ill contact among parts of present invention would not appear.

3. The structure of present invention is simple but effective, also keeps good conductive connection among parts, the circuit don't be cut off due to the rotation, thus, present invention can be a stable light source, and the lifetime of the bulb is also extended.

### BRIEF DESCRIPTION OF DRAWINGS

FIG. 1 is exploded view of the 1^{st} embodiment of present invention.

FIG. 2 is scheme of using the 1^{st} embodiment of present invention.

FIG. 3 is exploded view of the 2^{nd} embodiment of present invention.

### DETAIL DESCRIPTION

Further description of present invention with embodiments and drawings are as following:

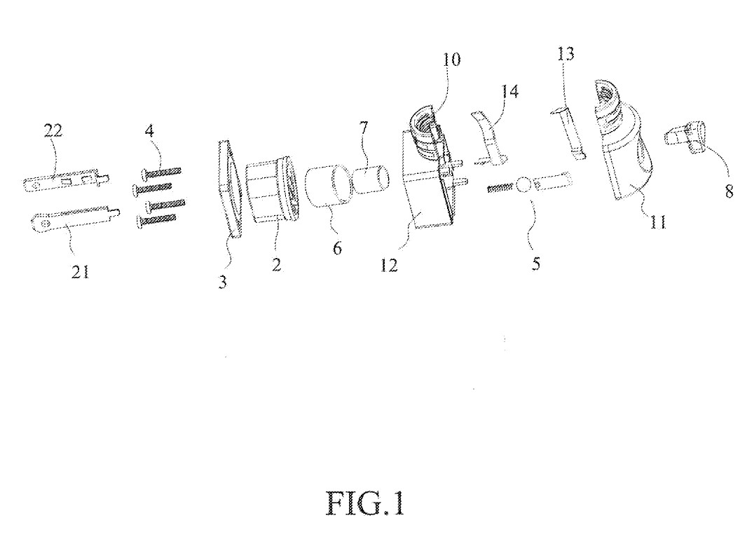

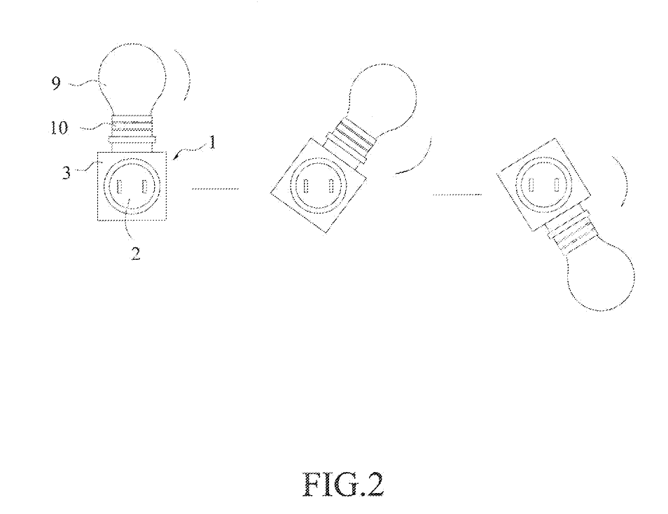

As FIGS. 1 and 2 shown, present invention is a rotatable night lamp holder, which comprises: a shell 1, a plug unit 2 and an annular jammer 3.

Said shell 1 is assembled by a front holder 11 and rear holder 12, a joint 10 for installing the bulb is positioned on the top of said shell, and the laminated electrodes 13,14 for electrical connection between the bulb and the holder is solid mounted inside said joint 10.

Said plug unit 2 is installed on the back of said rear holder 12, the conducting plates 21, 22 are solid fixed on said plug unit 2; and said plug unit 2 also comprises an annular jammer 3, which is fixed on said shell 1 by screws 4, the plug unit 2 is connected to said shell 1 by said annular jammer 3 which also makes the plug unit 2 become rotatable; said front holder 11 and rear holder 12 is fixed and assembled by the screws 4 which are for fixing said annular jammer 3 on said shell 1.

Said electrodes 13, 14 inside the joint 10 is separately connected with correspond conducting plate 21, 22 on the plug unit 2. A triggering switch 5 is disposed between the electrode 13 and the conducting plate 14.

Said conducting plates 21, 22 are separately electrical connected with large conductive ring 6 and small conductive ring 7 which are and disposed as a concentric cylinder, and fixed on said plug unit 2; the electrode 13 is connected to the large conductive ring 6 through said triggering switch 5, another electrode 14 is connected to the small conductive ring 7.

There is a socket which is formed on the tail of said conducting plate 21, the edge of said large conductive ring 6 is inserted into said socket; the tail of another conducting plate 22 is bended toward the center of said conductive rings 21, 22 at the position which is connected to the small conductive ring 7 to form a contact between them, a socket is also formed on the tail of the conducting plate 22 which is connected to the small conductive ring 7, for the insertion of the edge of said small conductive ring 7.

A switch button 8 is disposed on the front holder 11 of said shell 1, the switch button 8 works with said triggering switch 5 for linking or cutting the electrical connection between said electrode 13 and large conductive ring 6.

As FIG. 2 shown, to use present invention, first, install the bulb 9 on the joint 10, then plugging the plug unit 2 into the outlet, and rotate the shell 1 to desirable angle. Because the electrodes inside the joint 10 contact with centric cylinder disposing large conductive ring 6 and small conductive 7, no matter how the shell 1 is rotated, the linking of the circuit is still stable without any interruptions.

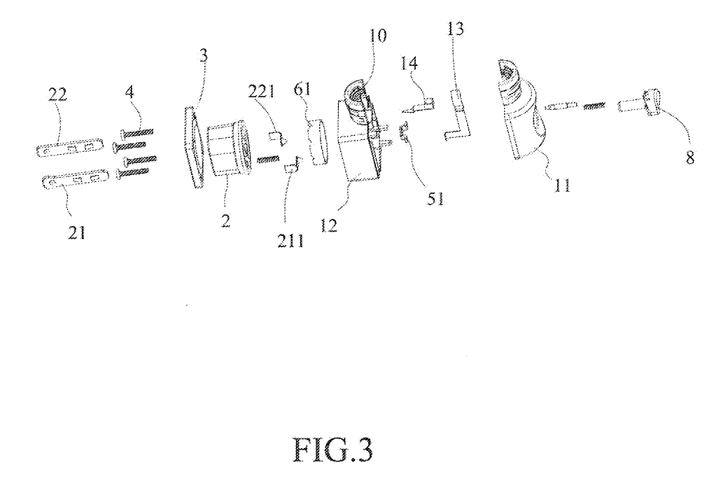

FIG. 3 reveals another embodiment of present invention, which has similar structure with aforementioned embodiment. The different point of this embodiment is applying only one conductive ring 61, one conducting plate 22 directly forms electrical connection with the electrode 14 inside the joint 10 through the conducting chip 221, because said conducting chip 221 is at the center of the plug unit 2, the position of conducting chip 221 would not be changed whether how the shell 1 is rotated, and the electrical connection between said conducting chip 221 and electrode 14 is not going to break; another conducting plate 21 also contacts with another conducting chip 211, and contact with said conductive ring 61 by a switch contactor 51, said conductive ring 61 has an electrical connection with another electrode 13, and the link or cut of the electrical connection is controlled by the switch button 8.

The description with drawings only represents the best embodiment, but not the limitation of present invention. The modification or changes according to the scope of present invention should be deemed to be infringement of below-listed claims.

1. A rotatable night lamp holder, which comprises:
A shell 1, which is assembled by a front holder 11 and rear holder 12, a joint 10 for installing the bulb is positioned on the top of said shell, and the laminated electrodes 13,14 for electrical connection between the bulb and the holder is solid mounted inside said joint 10;
A plug unit 2, which is installed on the back of said rear holder 12, the conducting plates 21, 22 are solid fixed on said plug unit 2;
Said plug unit 2 characterized by:
It also comprises an annular jammer 3, which is fixed on said shell 1 by screws 4, the plug unit 2 is connected to said shell 1 by said annular jammer 3 which also makes the plug unit 2 become rotatable; said front holder 11 and rear holder 12 is fixed and assembled by the screws 4 which are for fixing said annular jammer 3 on said shell 1.
Said electrodes 13, 14 inside the joint 10 is separately connected with correspond conducting plate 21, 22 on the plug unit 2. A triggering switch 5 is disposed between the electrode 13 and the conducting plate 14.

2. A rotatable night lamp holder according to claim 1, wherein said conducting plates 21, 22 are separately electrical connected with large conductive ring 6 and small conductive ring 7 which are and disposed as a concentric cylinder, and fixed on said plug unit 2; the electrode 13 is connected to the large conductive ring 6 through said triggering switch 5, another electrode 14 is connected to the small conductive ring 7.

3. A rotatable night lamp holder according to claim 2, wherein said conducting plate 21, 22 both have a socket which are formed on the tail, the edge of said large conductive ring 6 is inserted into the socket of said conducting plate 21; the tail of another conducting plate 22 is bended toward the center of said conductive rings 21, 22 at the position which is connected to the small conductive ring 7 to form a contact between them, the socket of the conducting plate 22 is for the insertion of the edge of said small conductive ring 7, and contact with it.

4. A rotatable night lamp holder according to claim 2, wherein said switch button 8 is disposed on the front holder 11 of said shell 1, the switch button 8 works with said triggering switch 5 for linking or cutting the electrical connection between said electrode 13 and large conductive ring 6.

5. A rotatable night lamp holder according to claim 2, wherein said front holder 11 and rear holder 12 is fixed and assembled by the screws 4 which are for fixing said annular jammer 3 on said shell 1.
